(19) United States
(12) Patent Application Publication
(10) Pub. No.: US 2026/0170027 A1
(43) Pub. Date: Jun. 18, 2026

(54) METHOD AND DEVICE WITH DATA FILTERING

(71) Applicant: Samsung Electronics Co., Ltd., Suwon-si (KR)

(72) Inventors: Hyeongseok SON, Suwon-si (KR); Kyuhyun SHIM, Suwon-si (KR); Joonho JANG, Suwon-si (KR); SANGIL JUNG, Suwon-si (KR)

(73) Assignee: Samsung Electronics Co., Ltd., Suwon-si (KR)

(21) Appl. No.: 19/221,372

(22) Filed: May 28, 2025

(30) Foreign Application Priority Data
Dec. 12, 2024 (KR) 10-2024-0185004

(51) Int. Cl. G06F 16/3329

(52) U.S. Cl. CPC G06F 16/33295

(57) ABSTRACT

A processor-implemented method includes obtaining question and answer (Q&A) data comprising an image, a question corresponding to the image, and a ground truth answer, generating an answer to the question by applying the image and the question to a first generative model, and determining whether to include the Q&A data in training data based on the ground truth answer and the answer.

### CROSS-REFERENCE TO RELATED APPLICATIONS

This application claims the benefit under 35 USC § 119(a) of Korean Patent Application

No. 10-2024-0185004, filed on Dec. 12, 2024 in the Korean Intellectual Property Office, the entire disclosure of which is incorporated herein by reference for all purposes.

### BACKGROUND

### 1. Field

The following description relates to a method and device with data filtering.

### 2. Description of Related Art

Data filtering is a method used to extract information from a large volume of data. For example, data filtering may include a process of extracting information from a large volume of data based on a specific criteria and/or a process of removing unnecessary data. A filtering method may be implemented in various schemes, such as condition-based filtering, a machine learning algorithm, and a signal processing technique. However, typical data filtering may not sufficiently improve the quality of data, may not sufficiently enhance the data processing speed, and/or may not sufficiently increase the reliability of a result by minimizing an error.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes obtaining question and answer (Q&A) data comprising an image, a question corresponding to the image, and a ground truth answer, generating an answer to the question by applying the image and the question to a first generative model, and determining whether to include the Q&A data in training data based on the ground truth answer and the answer.

The determining of whether to include the Q&A data in the training data may include determining whether the answer corresponds to the ground truth answer, and determining whether to include the Q&A data in the training data based on a result of the determining of whether the answer corresponds to the ground truth answer.

The determining of whether to include the Q&A data in the training data based on the result of the determining of whether the answer corresponds to the ground truth answer may include either one of, in response to determining that the answer corresponds to the ground truth answer, determining to include the Q&A data in the training data, and, in response to determining that the answer does not correspond to the ground truth answer, removing the Q&A data from the training data.

The method may include, in response to determining to include the Q&A data in the training data, including the Q&A data in the training data, and training the first generative model based on the training data including the Q&A data.

The Q&A data further may include options for the question.

The generating of the answer to the question may include generating the answer to the question by applying the image, the question, and the options to the first generative model.

The answer may be determined to be one of items comprised in the options.

The generating of the answer to the question may include changing the options, and generating the answer to the question by applying the image, the question, and the changed options to the first generative model.

The changing of the options may include any one or any combination of any two or more of changing an order of items comprised in the options, changing an item comprised in the options,
adding a new item to the options, and removing an item included the options.

The changing of the options may include adding an item indicating that a ground truth answer does not exist in the options.

The generating of the answer to the question may include generating an answer set to a question data set comprising the image, the question, and the options by applying the question data set to the first generative model, and the question data set may include first question data comprising the image, the question, and first options and second question data comprising the image, the question, and second options.

The determining of whether to include the Q&A data in the training data may include determining a level of correspondence between the answer set and the ground truth answer, and determining whether to remove the Q&A data from the training data based on the level of correspondence.

The obtaining of the Q&A data may include generating the Q&A data by applying an image and a prompt for question generation to a second generative model.

The second generative model may be the same as the first generative model.

The second generative model may be different from the first generative model.

The generating of the Q&A data may include generating the Q&A data by further applying context data corresponding to the image to the second generative model.

The generating of the answer to the question may include generating a descriptive answer to the question by further applying a prompt for requesting a descriptive answer to the question to the first generative model.

In one or more general aspects, a processor-implemented method includes obtaining question and answer (Q&A) data comprising an image, a question corresponding to the image, and a ground truth answer, generating an answer to the question by applying the image and the question to a first generative model, and in response to determining that the answer corresponds to the ground truth answer, training the first generative model based on the Q&A data.

In one or more general aspects, an electronic device includes one or more processors configured to obtain question and answer (Q&A) data comprising an image, a question corresponding to the image, and a ground truth answer, obtain an answer to the question by applying the image and the question to a first generative model, and determine whether to include the Q&A data in training data based on the ground truth answer and the answer.

For the determining of whether to include the Q&A data in the training data, the one or more processors may be configured to determine whether the answer corresponds to the ground truth answer, and determine whether to include the Q&A data in the training data based on a result of the determination.

Other features and aspects will be apparent from the following detailed description, the drawings, and the claims.

### BRIEF DESCRIPTION OF THE DRAWINGS

FIG. 1 is a flowchart of operations of a data processing method for training a neural network according to one or more embodiments.

FIG. 2 is a diagram illustrating question and answer (Q&A) data corresponding to an image according to one or more embodiments.

FIG. 3 is a diagram illustrating an operation of a system for data processing for training a neural network according to one or more embodiments.

FIG. 4 is a diagram illustrating an operation of generating Q&A data based on context data according to one or more embodiments.

FIG. 5 is a diagram illustrating a filtering operation on Q&A data including an option according to one or more embodiments.

FIG. 6 is a diagram illustrating an operation of generating a set of question data and a set of answers to the question data according to one or more embodiments.

FIG. 7 is a flowchart of operations of a method of filtering training data by determining a level of correspondence of a set of answers and a ground truth answer according to one or more embodiments.

FIG. 8 illustrates an example of a configuration of an electronic device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

In connection with the description of the drawings, like reference numerals may be used for similar or related components. It is to be understood that a singular form of a noun corresponding to an item may include one or more of the things, unless the relevant context clearly indicates otherwise.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which the present disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Hereinafter, embodiments will be described in detail with reference to the accompanying drawings. When describing the embodiments with reference to the accompanying drawings, like reference numerals refer to like elements and a repeated description related thereto will be omitted.

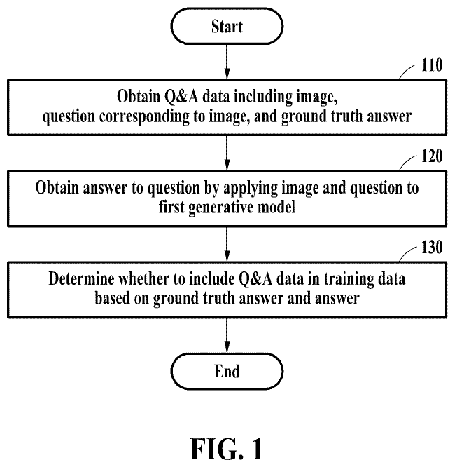

FIG. 1 is a flowchart of operations of a data processing method for training a neural network according to one or more embodiments.

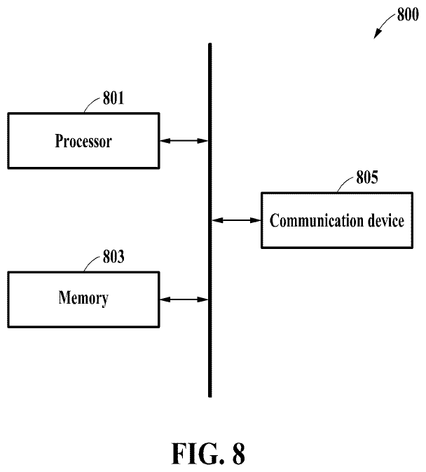

The data processing method for training a neural network according to one or more embodiments may be performed by an electronic device (e.g., an electronic device 800 of FIG. 8) including at least one processor (e.g., a processor 801 of FIG. 8). An example of a specific hardware configuration of the electronic device is described below (e.g., FIG. 8).

Hereinafter, data for training the neural network may be referred to as training data. The training data according to one or more embodiments may include at least one piece of question and answer (Q&A) data. The training data may be data used to train a neural network-based model. For example, the training data may include data for training a model that generates a question related to an image and a model that solves (e.g., answers) a question related to the image. For example, a model that is trained using the training data may include various deep learning-based neural networks, such as a natural language processing model and/or a generative model.

Referring to FIG. 1, the data processing method according to one or more embodiments may include operation 110 of obtaining Q&A data including an image, a question corresponding to the image, and ground truth.

The Q&A data may correspond to a data set including the image, the question corresponding to the image, and the ground truth. The question corresponding to the image may be a question that may be derived from the image and may include, for example, at least one of a question related to the image, a question based on information contained in the image, and/or a question based on information obtained from the image. The ground truth may correspond to data indicating the ground truth to the question (e.g., a correct answer to the question). The ground truth may be text data including at least one word or at least one sentence.

According to one or more embodiments, the Q&A data may include an option for the question. When the option is included in the Q&A data, the question may be a multiple choice type question. When the option is included, the ground truth may be data indicating at least one of items included in the option.

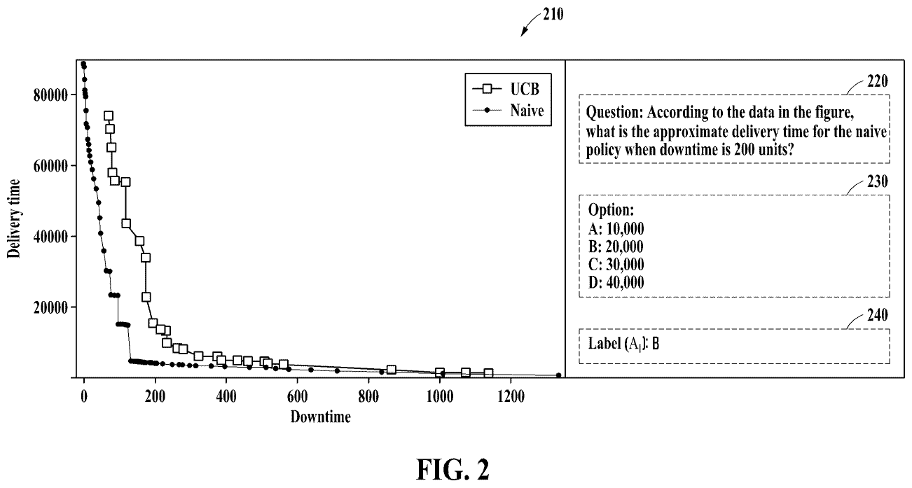

For example, referring to FIG. 2, the Q&A data may include an image 210 and a question 220 corresponding to the image 210. When the image 210 is an image illustrating a specific graph, the question 220 corresponding to the image 210 may include a question asking for information determined by interpreting the graph, such as a question on a y value corresponding to a specific x value of the graph.

The Q&A data may include an option 230 for the question 220. The options 230 may include four items that may be selected to be an answer to the question 220. At least one of the items included in the option 230 may be a ground truth item.

The Q&A data may include a ground truth answer 240 of the question 220. The ground truth answer 240 may indicate at least one of the items included in the option 230.

Referring back to FIG. 1, according to one or more embodiments, operation 110 of obtaining the Q&A data may include an operation of obtaining the Q&A data by applying a prompt for generating an image and a question to a generative model.

The generative model may be an artificial intelligence (AI) neural network that generates new data (e.g., text, an image, audio, and/or a video) based on a user input (e.g., a user utterance and/or a text input). The generative model may include, for example, at least one of a large language model (LLM), a large multimodal model (LMM), and/or a multi-modal foundation model (MMFM).

To distinguish between the generative model that generates the Q&A data and the generative model that generates an answer, hereinafter, the generative model that generates an answer may be referred to as a first generative model and the generative model that generates the Q&A data may be referred to as a second generative model. The first generative model and the second generative model may be the same or different from each other.

A prompt for generating a question may include data that sends a request to the generative model to generate a question on an image. For example, the prompt for generating a question may include data that requests to generate a question on an image that may be answered with a short answer. For example, the prompt for generating a question may include data that requests to generate a question on an image and options including a ground truth item. Hereinafter, the prompt for generating a question may be referred to as a question generation prompt.

According to one or more embodiments, operation 110 of obtaining the Q&A data may include an operation of obtaining the Q&A data by applying context data of the image to the generative model. An example of the context data is described below.

The data processing method according to one or more embodiments may include operation 120 of obtaining an answer to the question by applying the image and the question to the first generative model. The image and the question applied to the first generative model may include the image and the question included in the Q&A data obtained in operation 110.

According to one or more embodiments, operation 120 of obtaining the answer to the question may include an operation of obtaining the answer to the question by applying the image, the question, and the option to the first generative model. The answer may be determined to be one of the items included in the option. The image, the question, and the option applied to the first generative model may include the image, the question, and the option included in the Q&A data obtained in operation 110.

According to one or more embodiments, the operation of obtaining the answer to the question may include an operation of changing the option and an operation of obtaining the answer to the question by applying the image, the question, and the changed option to the first generative model.

Changing the option may represent changing the option included in the Q&A data obtained in operation 110. For example, the operation of changing the option may include an operation of changing the order of items included in the option. For example, the operation of changing the option may include an operation of changing an item included in the option. Changing the item included in the option may represent changing information indicated by the item included in the option to other information. For example, the operation of changing the option may include an operation of adding a new item to the option. The option may be changed to include more items by adding an item indicating new information that was not included in the option included in the original Q&A data. For example, the operation of changing the option may include an operation of adding an item indicating that there is no ground truth answer in the option. The item indicating that there is no ground truth answer may be an item indicating that all other items included in the option are not the ground truth answer to the question. When all other items included in the option are not the ground truth answer, the item indicating that there is no ground truth answer may be the ground truth answer to the question. For example, the operation of changing the option may include an operation of removing an item included in the option.

According to one or more embodiments, operation 120 of obtaining an answer to the question may include an operation of obtaining a descriptive answer to the question by further applying a prompt that sends a request to the first generative model for a descriptive answer to the question. The prompt that requests a descriptive answer may include data that requests to describe a process of generating an answer to the question. For example, the accuracy of the answer to the question generated by the first generative model may be improved by applying a prompt for requesting a process of generating an answer to the first generative model.

The data processing method according to one or more embodiments may include operation 130 of determining whether to include the Q&A data in the training data based on the ground truth answer and the answer. The reliability of the Q&A data may be verified by comparing the answer to the question generated by the first generative model with the ground truth answer included in the Q&A data. The reliability of the Q&A data may correspond to a probability that the ground truth answer included in the Q&A data is a correct answer to the question. Based on the reliability of the Q&A data, whether to determine the Q&A data to be the training data or whether to remove the Q&A data from the training data may be determined.

For example, operation 130 of determining whether to include the Q&A data in the training data based on the ground truth answer and the answer may correspond to an operation of filtering the training data. In other words, the training data may be filtered to remove the Q&A data with low reliability and include only the Q&A data with high reliability from the Q&A data included in the training data.

According to one or more embodiments, operation 130 of determining whether to include the Q&A data in the training data may include an operation of determining whether the answer corresponds to the ground truth answer and an operation of determining whether to include the Q&A data in the training data based on a result of determination. Whether the answer corresponds to the ground truth answer may represent whether the answer indicates the same information indicated by the ground truth answer. For example, when the ground truth answer is a specific word, and when the answer is the word or a word indicating the same meaning of the word, it may be determined that the answer corresponds to the ground truth answer. For example, when the ground truth answer indicates an item of a specific option, and when the answer indicates the same item of the option as the ground truth answer or when it is determined that the answer is the same as the item of the option indicated by the ground truth answer, it may be determined that the answer corresponds to the ground truth answer.

According to one or more embodiments, based on the result of determination, the operation of determining whether to include the Q&A data in the training data may include an operation of determining to include the Q&A data in the training data when it is determined that the answer corresponds to the ground truth answer and an operation of removing the Q&A data from the training data when it is determined that the answer does not to correspond to the ground truth data.

According to one or more embodiments, operation 120 of obtaining the answer to the question may include an operation of obtaining a set of questions on a question data set by applying the question data set including the image, the question, and the option, to the first generative model. The question data set may include a plurality of pieces of question data including different options. For example, the question data set may include first question data including an image, a question, and a first option and second question data including an image, a question, and a second option.

According to one or more embodiments, operation 130 of determining whether to include the Q&A data in the training data may include an operation of determining a level of correspondence between a set of answers and the ground truth answer and an operation of determining whether to remove the Q&A data from the training data based on the correspondence level. In an example, operation 130 may further include including the Q&A data in the training data and training either one or both of the first generative model and the second generative model based on the training data including the Q&A data, in response to determining to include the Q&A data in the training data.

An example of an operation of determining whether to include the Q&A data in the training data based on the set of answers to the question data set is described below.

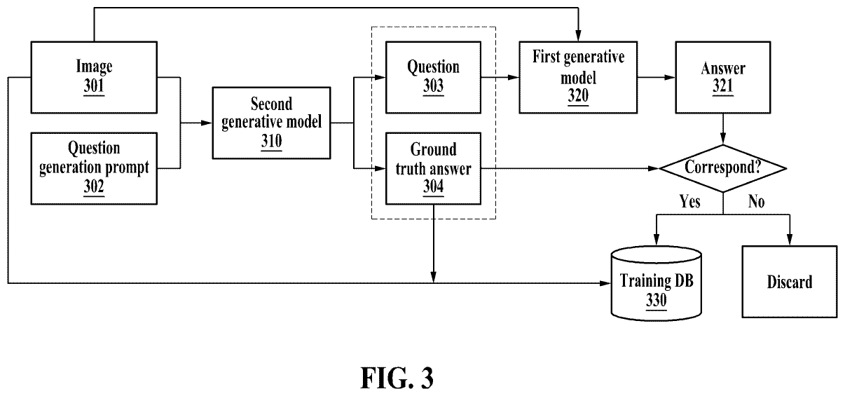

FIG. 3 is a diagram illustrating an operation of a system for data processing for training a neural network according to one or more embodiments.

Referring to FIG. 3, Q&A data according to one or more embodiments may include an image 301, a question 303 generated from the image 301, and a ground truth answer 304. The question 303 and the ground truth answer 304 corresponding to the image 301 included in the Q&A data may be obtained from a second generative model 310. The second generative model 310 may generate the question 303 and the ground truth answer 304 corresponding to the input image 301 and a question generation prompt 302. For example, the question generation prompt 302 may include data for requesting to generate a question related to the input image 301.

According to one or more embodiments, among the generated Q&A data, the image 301 and the question 303 may be input to a first generative model 320. The first generative model 320 may output an answer 321 corresponding to the input image 301 and the question 303. The answer 321 output from the first generative model 320 may be a result of solving the question 303 related to the image 301.

Based on the correspondence between the answer 321 and the ground truth answer 304, whether to store the Q&A data including the image 301, the question 303, and the ground truth answer 304 in a training database 330 or remove the Q&A data from the training database 330 may be determined. The training database 330 may be a database for storing the training data and may store at least one piece of Q&A data. As described above, the correspondence between the answer 321 and the ground truth answer 304 may be determined whether the answer 321 indicates the same information indicated by the ground truth answer 304.

When the answer 321 output from the first generative model 320 corresponds to the ground truth answer 304, the ground truth answer 304 included in the Q&A data may be determined to be an appropriate answer to the question 303 related to the image 301, and thereby, the Q&A data may be stored in the training database.

When the answer 321 output from the first generative model 320 does not correspond to the ground truth answer 304, the ground truth answer 304 included in the Q&A data may be determined to be an inappropriate answer to the question 303 related to the image 301, and thereby, the Q&A data may be removed from the training database 330.

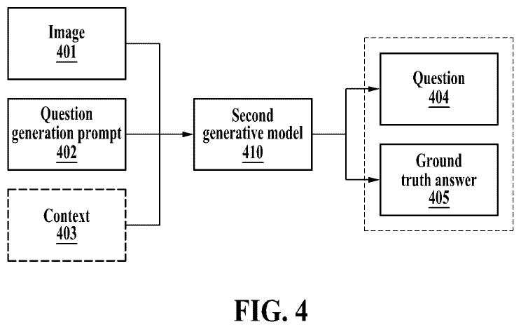

FIG. 4 is a diagram illustrating an operation of generating Q&A data based on context data according to one or more embodiments.

Referring to FIG. 4, an image 401, a question generation prompt 402, and context data 403 of the image 401 may be input to a second generative model 410. The context data 403 may be information that describes the image 401 and may include, for example, at least one of caption data of the image 401, a paragraph including a description of the image 401 in a document (e.g., a thesis) including the image 401, and/or data obtained by searching for the image 401.

According to one or more embodiments, the data processing method may include an operation of obtaining a search result of the image 401. The search result of the image 401 may be processed into the context data 403 to be input to the second generative model 410 and may be input to the second generative model 410. For example, the context data 403 of the image 401 may include data that describes a variable included in the image 401.

The second generative model 410 may generate a question 404 and a ground truth answer 405 of the image 401 by referring to the context data 403. The Q&A data including the image 401, the question 404 and the ground truth answer 405 corresponding to the image 401 may be generated, wherein the question 404 and the ground truth answer 405 are obtained by the second generative model 410.

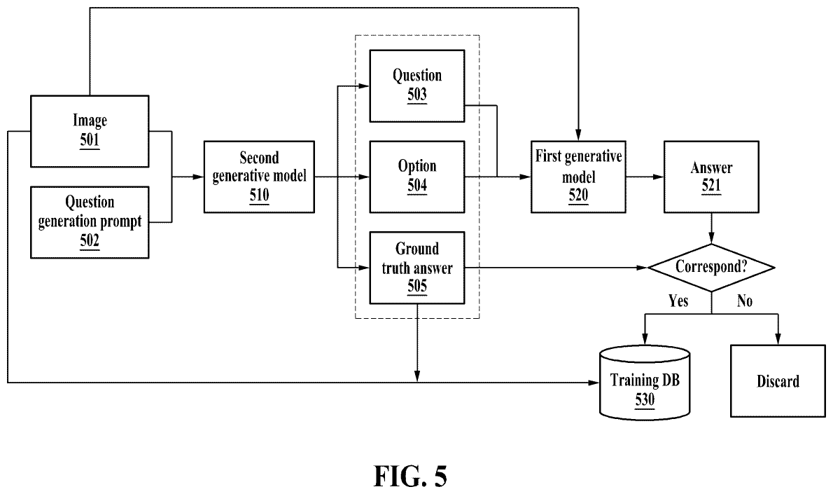

FIG. 5 is a diagram illustrating a filtering operation on Q&A data including an option according to one or more embodiments.

Referring to FIG. 5, Q&A data according to one or more embodiments may include an image 501, a question 503 generated from the image 501, an option 504, and a ground truth answer 505. The question 503, the option 504, and the ground truth answer 505 corresponding to the image 501 included in the Q&A data may be obtained by a second generative model 510. The second generative model 501 may generate the question 503 and the ground truth answer 505 corresponding to the input image 501 and a question generation prompt 502. For example, the question generation prompt 502 may include data for requesting to generate a multiple choice question on the input image 501. For example, the question generation prompt 502 may include data for requesting to generate the question 503 on the input image 501 and the option 504 including n items (n is a natural number greater than or equal to 2) to be selected to be an answer to the question 503.

According to one or more embodiments, among the generated Q&A data, the image 501, the question 503, and the option 504 may be input to a first generative model 520. For example, the option 504 included in the Q&A data may be changed and may be input to the first generative model 520. The first generative model 520 may output an answer 521 corresponding to the input image 501, the question, 503, and the option 504. The answer 521 output from the first generative model 520 may be a result of solving the multiple choice question 503 related to the image 501.

Based on the correspondence between the answer 521 and the ground truth answer 505, whether to store the Q&A data including the image 501, the question 503, the option 504, and the ground truth answer 505 in a training database 530 or remove the Q&A data from the training database 530 may be determined. The training database 530 may be a database for storing the training data and may store at least one piece of Q&A data.

As described above, the correspondence between the answer 521 and the ground truth answer 505 may be determined whether the answer 521 indicates the same information indicated by the ground truth answer 505. For example, when the ground truth answer 505 indicates one of the items included in the option 504, and when the answer 521 indicates the same information as the information of the item indicated by the ground truth answer 505, it may be determined that the answer 521 corresponds to the ground truth answer 505.

When the answer 521 output from the first generative model 520 corresponds to the ground truth answer 505, the ground truth answer 505 included in the Q&A data may be determined to be an appropriate answer to the question 503 related to the image 501, and thereby, the Q&A data may be stored in the training database 530.

When the answer 521 output from the first generative model 520 does not correspond to the ground truth answer 505, the ground truth answer 505 included in the Q&A data may be determined to be an inappropriate answer to the question 503 related to the image 501, and thereby, the Q&A data may be removed from the training database 530.

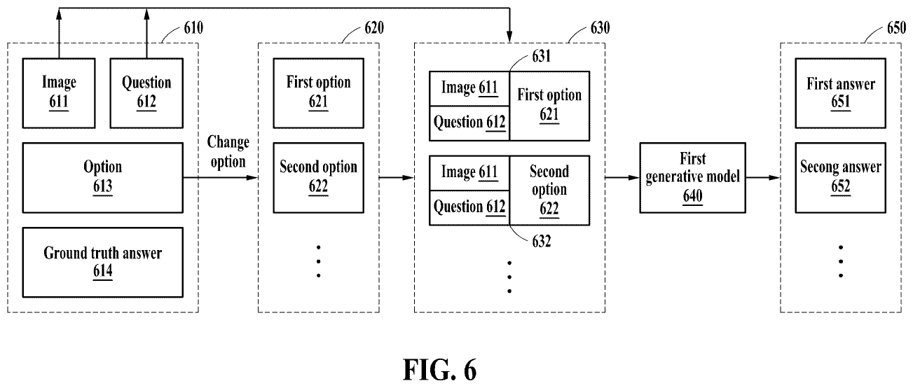

FIG. 6 is a diagram illustrating an operation of generating a set of question data and a set of answers to the question data according to one or more embodiments.

Referring to FIG. 6, by changing an option 613 included in Q&A data 610, an option set 620 including a plurality of changed options may be generated. iThe option set 620 may further include an original option 613 included in the Q&A data 610.

As described above, changing the option 613 may include at least one of changing the order of items included in the option 613, changing an item included in the option 613, including a new item (e.g., an item indicating that there is no ground truth answer) in the option 613, and/or removing an item included in the option 613.

For example, the option set 620 may include a first option 621 and a second option 622. For example, an item included in the first option 621 and an item included in the second option 622 may be at least partially different from each other. For example, the order of items included in the first option 621 and the order of items included in the second option 622 may be different from each other. For example, the number of items included in the first option 621 and the number of items included in the second option 622 may be different from each other.

A question data set 630 may include a plurality of pieces of question data including an image 611, a question 612, and different options. For example, the question data set 630 may include first question data 631 and second question data 632. The first question data 631 may include the image 611, the question 612, and the first option 621. The second question data 632 may include the image 611, the question 612, and the second option 622.

The question data included in the set of question data 630 may be input to a first generative model 640 according to one or more embodiments. An answer set 650 may include an answer generated by the first generative model 640 in correspondence with each piece of question data included in the question data set 630. For example, the answer set 650 may include a first answer 651 generated in correspondence with the first question data 631 and a second answer 652 generated in correspondence with the second question data 632. For example, the first answer 651 may be generated by inputting the first question data 631 to the first generative model 640, and the second answer 652 may be generated by inputting the second question data 632 to the first generative model 640.

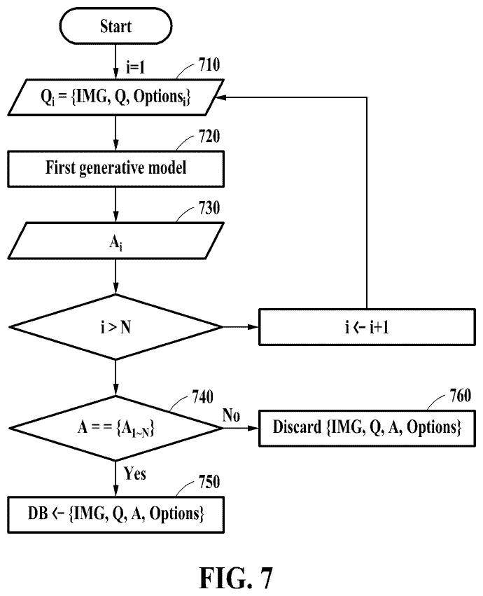

FIG. 7 is a flowchart of operations of a method of filtering training data by determining a level of correspondence of a set of answers and a ground truth answer according to one or more embodiments. Operations 710 to 760 of FIG. 7 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 7, when Qᵢ 710 is i-th question data, Qᵢ 710 may include an image IMG, a question Q, and an i-th option Optionsᵢ. An answer Aᵢ 730 may be obtained by applying Qᵢ={IMG, Q, Optionsᵢ} 710 to a first generative model 720. The answer Aᵢ 730 to each piece of question data Qᵢ 710 may be obtained by inputting first question data Q₁ to the first generative model.

When the number of question data pieces included in the question data set is N, up to N-th question data Q_{N} may be input to the first generative model 720 and an answer set {A₁, A₂, . . . , A_{N}} including N answers may be obtained.

According to one or more embodiments, when a ground truth answer included in the Q&A data is A, whether each answer included in the answer set {A₁ to _{N}} corresponds to the ground truth answer A may be determined 740. The operation of determining 740 whether each answer included in the answer set {A_{1 to N}} corresponds to the ground truth answer A may include an operation of determining whether an answer Aₖ included in the answer set {A_{1 to N}} corresponds to the ground truth answer A from k=1 to N. As described above, whether each answer corresponds to the ground truth answer may represent whether each answer indicates the same information indicated by the ground truth answer.

When all of the answers included in the answer set correspond to the ground truth answer A, the Q&A data {IMG, Q, A, Options} including the image IMG, the question Q, the option Options may be determined to be the training data and may be stored 750 in a training database DB.

Among the answers included in the answer set, an answer that does not correspond to the ground truth answer A exists, the Q&A data {IMG, Q, A, Options} may be removed (discarded) 760 from the training database.

According to one or more embodiments, unlike FIG. 7, whether to determine the Q&A data to be the training data may be determined based on whether the number of answers corresponding to the ground truth answer among the answers included in the answer set is greater than or equal to a threshold number or a threshold percentage.

Determining the Q&A data {IMG, Q, A, Options} including an inaccurate ground truth answer A to be to be the training data as the first generative model 720 accidentally outputs an answer corresponding to the ground truth answer A may be prevented by determining 740 the correspondence between the ground truth answer A and the answer set {A_{1 to N}} of the first generative model 720 obtained with respect to the plurality of pieces of question data Q₁ to Q_{N}.

FIG. 8 illustrates an example of a configuration of an electronic device according to one or more embodiments.

Referring to FIG, 8, an electronic device 800 according to one or more embodiments may include a processor 801 (e.g., one or more processors), a memory 803 (e.g., one or more memories), and a communication device 805. The electronic device 800 according to one or more embodiments may include a device for performing the data processing method described above with reference to FIGS. 1 to 7. For example, the electronic device 800 may include a server or a terminal (e.g., a personal computer (PC), a smartphone, a tablet, and/or a wearable device).

The processor 801 according to one or more embodiments may perform at least one operation of the data processing method described above with reference to FIGS. 1 to 7. For example, the processor 801 may perform at least one of an operation of obtaining the Q&A data including an image and obtaining a question corresponding to the image, an operation of obtaining an answer to the question by applying the image and the question to the first generative model and obtaining a ground truth answer, and/or an operation of determining whether to include the Q&A data in the training data based on the ground truth answer and the answer.

The memory 803 according to one or more embodiments may be a volatile or non-volatile memory, and may store data related to the data processing method described above with reference to FIGS. 1 to 7. For example, the memory 803 may store data generated while performing the data processing method, and/or data required to perform the image processing method. For example, the memory 803 may store the Q&A data. For example, the memory 803 may include a training database.

The communication device 805 according to one or more embodiments may provide a function for the electronic device 800 to communicate with another electronic device or another server via a network. In other words, the electronic device 800 may be connected to an external device (e.g., a terminal, a server, and/or a network) via the communication device 805 and may exchange data.

According to one or more embodiments, the memory 803 may not be a component of the electronic device 800 and may be included in an external device accessible by the electronic device 800. In this case, the electronic device 800 may receive data stored in the memory 803 included in the external device via the communication device 805 and may transmit data to be stored in the memory 803.

According to one or more embodiments, the memory 803 may store a program in which the data processing method described above with reference to FIGS. 1 to 7 is implemented. The processor 801 may execute the program stored in the memory 803 and may control the electronic device 800. Codes of the program executed by the processor 801 may be stored in the memory 803. For example, the memory 803 may be or include a non-transitory computer-readable storage medium storing code that, when executed by the processor 801, configures the processor 801 to perform any one, any combination, or all of the operations and/or methods disclosed herein with reference to FIGS. 1-7.

According to one or more embodiments, the memory 803 may store instructions. When executed by one or more processors 801, the instructions stored in the memory 803 may cause the electronic device 800 to obtain the Q&A data including an image, a question corresponding to the image, and a ground truth answer, obtain an answer to the question by applying the image and the question to the first generative model, and determine whether to include the Q&A data in the training data based on the ground truth answer and the answer.

The electronic device 800 may further include a component that is not shown in the drawings. For example, the electronic device 800 may further include an input/output interface including an input device and an output device as a means for an interface with the communication device 805. For example, the electronic device 800 may further include other components, such as a transceiver, various sensors, and a database.

The electronic devices, processors, memories, communication devices, electronic device 800, processor 801, memory 803, and communication device 805 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
obtaining question and answer (Q&A) data comprising an image, a question corresponding to the image, and a ground truth answer;
generating an answer to the question by applying the image and the question to a first generative model; and
determining whether to include the Q&A data in training data based on the ground truth answer and the answer.

2. The method of claim 1, wherein the determining of whether to include the Q&A data in the training data comprises:
determining whether the answer corresponds to the ground truth answer; and
determining whether to include the Q&A data in the training data based on a result of the determining of whether the answer corresponds to the ground truth answer.

3. The method of claim 2, wherein the determining of whether to include the Q&A data in the training data based on the result of the determining of whether the answer corresponds to the ground truth answer comprises either one of:
in response to determining that the answer corresponds to the ground truth answer, determining to include the Q&A data in the training data; and
in response to determining that the answer does not correspond to the ground truth answer, removing the Q&A data from the training data.

4. The method of claim 3, further comprising, in response to determining to include the Q&A data in the training data:
including the Q&A data in the training data; and
training the first generative model based on the training data including the Q&A data.

5. The method of claim 1, wherein the Q&A data further comprises options for the question.

6. The method of claim 5, wherein the generating of the answer to the question comprises generating the answer to the question by applying the image, the question, and the options to the first generative model.

7. The method of claim 5, wherein the answer is determined to be one of items comprised in the options.

8. The method of claim 5, wherein the generating of the answer to the question comprises:
changing the options; and
generating the answer to the question by applying the image, the question, and the changed options to the first generative model.

9. The method of claim 8, wherein the changing of the options comprises any one or any combination of any two or more of:
changing an order of items comprised in the options;
changing an item comprised in the options;
adding a new item to the options; and
removing an item included the options.

10. The method of claim 8, wherein the changing of the options comprises adding an item indicating that a ground truth answer does not exist in the options.

11. The method of claim 5, wherein
the generating of the answer to the question comprises generating an answer set to a question data set comprising the image, the question, and the options by applying the question data set to the first generative model, and
the question data set comprises first question data comprising the image, the question, and first options and second question data comprising the image, the question, and second options.

12. The method of claim 11, wherein the determining of whether to include the Q&A data in the training data comprises:
determining a level of correspondence between the answer set and the ground truth answer; and
determining whether to remove the Q&A data from the training data based on the level of correspondence.

13. The method of claim 1, wherein the obtaining of the Q&A data comprises generating the Q&A data by applying an image and a prompt for question generation to a second generative model.

14. The method of claim 13, wherein the second generative model is the same as the first generative model.

15. The method of claim 13, wherein the second generative model is different from the first generative model.

16. The method of claim 13, wherein the generating of the Q&A data comprises generating the Q&A data by further applying context data corresponding to the image to the second generative model.

17. The method of claim 1, wherein the generating of the answer to the question comprises generating a descriptive answer to the question by further applying a prompt for requesting a descriptive answer to the question to the first generative model.

18. A non-transitory computer-readable storage medium storing instructions that, when executed by one or more processors, configure the one or more processors to perform:
obtain question and answer (Q&A) data comprising an image, a question corresponding to the image, and a ground truth answer;
generate an answer to the question by applying the image and the question to a first generative model; and
determine whether to include the Q&A data in taining data based on the ground truth answer and the answer.

19. An electronic device comprising:
one or more processors configured to:
obtain question and answer (Q&A) data comprising an image, a question corresponding to the image, and a ground truth answer;
generate an answer to the question by applying the image and the question to a first generative model; and
determine whether to include the Q&A data in training data based on the ground truth answer and the answer.

20. The electronic device of claim 19, wherein, for the determining of whether to include the Q&A data in the training data, the one or more processors are configured to:
determine whether the answer corresponds to the ground truth answer; and
determine whether to include the Q&A data in the training data based on a result of the determination.
